(19) United States
(12) Patent Application Publication
(10) Pub. No.: US 2026/0099648 A1
(43) Pub. Date: Apr. 9, 2026

(54) LENS SIMULATION METHOD AND SYSTEM THEREFOR

(71) Applicant: INDUSTRY-ACADEMIC COOPERATION FOUNDATION GYEONGSANG NATIONAL UNIVERSITY, Jinju-si Gyeongsangnam-do (KR)

(72) Inventors: Seong-Jae KIM, Jinju-si (KR); Hae-Jin KIM, Seoul (KR); Kyeong-hwan KIM, Jinju-si (KR); Youngsub EOM, Seoul (KR)

(73) Assignee: INDUSTRY-ACADEMIC COOPERATION FOUNDATION GYEONGSANG NATIONAL UNIVERSITY, Jinju-si Gyeongsangnam-do (KR)

(21) Appl. No.: 18/997,699

(22) PCT Filed: May 23, 2023
(86) PCT No.: PCT/KR2023/007030

§ 371 Date: Jan. 22, 2025

(30) Foreign Application Priority Data
May 24, 2022 (KR) 10-2022-0063312

(51) Int. Cl. G06F 30/27; G06F 111/04; G06F 111/10

(52) U.S. Cl. CPC G06F 30/27; G06F 2111/04; G06F 2111/10

(57) ABSTRACT

A deep learning-based lens simulation method and a system therefor are provided. The lens simulation method according to several embodiments of the present disclosure acquires a deep learning model constructed to predict optical characteristic values of a lens from an input pattern image, predicts, through the acquired deep learning model, optical characteristic values of a target lens from a pattern image associated with the target lens, and uses the predicted optical characteristic values so as to accurately simulate a visual field seen through the target lens.

### TECHNICAL FIELD

The present disclosure relates to a method for simulating a visual field seen through a lens and a system for performing the method.

### BACKGROUND ART

An intraocular lens implantation is a surgery to remove a clouded lens caused by a cataract and implant an intraocular lens. In recent years, not only monofocal intraocular lenses but also multifocal intraocular lenses are being widely used for cataract patients. A multifocal intraocular lens is an intraocular lens with multiple focal lengths, and is known to be able to see both near and far objects clearly.

However, patients who have undergone the intraocular lens implantation often undergo intraocular lens removal surgery due to dissatisfaction with the quality of the visual field. For example, some patients who have undergone multifocal intraocular lens implantation experience problems in which glare (see Image 1 in FIG. 1), halo, and starburst phenomena occur in the visual field, or objects at certain distances (e.g., objects that are between focal lengths of the multifocal intraocular lens) appear blurry. Therefore, before undergoing the intraocular lens implantation, a process is needed where patients may experience the visual field seen through the intraocular lens in advance and determine whether to undergo the surgery.

In this regard, a mobile model eye that may simulate the visual field seen through the intraocular lens outdoors has been proposed. However, since the proposed model eye requires an actual intraocular lens, there is a problem in that it is difficult to simulate various intraocular lenses with different optical characteristics without limitation.

### PRIOR ART DOCUMENT

### Patent Document

(Patent Document 1) Korean Patent Registration No. 10-2118995 (published on June 26, 2020)

### DISCLOSURE

### Technical Problem

A technical object to be achieved by some exemplary embodiments of the present disclosure is to provide a method which may accurately simulate a visual field seen through a lens and a system for performing the method.

Another technical object to be achieved by some exemplary embodiments of the present disclosure is to provide a method which may simulate various lenses having different optical characteristics without a limit and a system for performing the method.

Yet another technical object to be achieved by some exemplary embodiments of the present disclosure is to provide a method which may construct a deep learning model accurately predicting optical characteristic values of the lens and a system for performing the method.

Still yet another technical object to be achieved by some exemplary embodiments of the present disclosure is to provide a method which may easily generate a training set for constructing the deep learning model predicting the optical characteristic values of the lens and a system for performing the method.

Still yet another technical object to be achieved by some exemplary embodiments of the present disclosure is to provide a method which may accurately simulate the visual field seen through the lens by using the optical characteristic values of the lens and a system for performing the method.

The technical objects of the present disclosure are not restricted to the aforementioned technical objects, and other objects of the present disclosure, which are not mentioned above, will become more apparent to one of ordinary skill in the art to which the present disclosure pertains by referencing the detailed description of the present disclosure given below.

### Technical Solution

In order to achieve the above aspects, according to some exemplary embodiments of the present disclosure, provided is a lens simulation method performed by at least one computing device, which may include: acquiring a deep learning model constructed to predict optical characteristic values of a lens from an input pattern image; predicting, through the acquired deep learning model, optical characteristic values of a target lens from a pattern image associated with the target lens; and using the predicted optical characteristic values so as to simulate a visual field seen through the target lens.

In an exemplary embodiment, the pattern image may be a USAF target image.

In an exemplary embodiment, the optical characteristic values may include a modulation transfer function (MTF) value and a defocus value.

In an exemplary embodiment, the deep learning model may be a convolutional neural network based model.

In an exemplary embodiment, the target lens may be an intraocular lens.

In an exemplary embodiment, the simulating may include injecting a defocus effect according to the predicted optical characteristic values into an original visual field image.

In an exemplary embodiment, the predicted optical characteristic values may include the modulation transfer function (MTF) value and the defocus value, and the injecting of the defocus effect may include determining an intensity of a blur filter by using the MTF value and the defocus value, and applying the blur filter having the determined intensity to the original visual field image.

In an exemplary embodiment, the predicted optical characteristic values may include a first characteristic value corresponding to a first object distance and a second characteristic value corresponding to a second object distance different from the first object distance, and the injecting of the defocus effect may include injecting a defocus effect according to the first characteristic value into an area having the first object distance in the original visual field image, and injecting a defocus effect according to the second characteristic value into an area having the second object distance in the original visual field image.

In order to achieve the above aspects, according to other some exemplary embodiments of the present disclosure, provided is a lens simulation method performed by at least one computing device, which may include: acquiring a dataset constituted by a plurality of pattern images and optical characteristic values of a lens corresponding to the plurality of pattern images; generating a training set by preprocessing the acquired dataset; and constructing a deep learning model predicting the optical characteristic values of the lens from an input pattern image by using the generated training set.

In an exemplary embodiment, the generating of the training set may include setting an alignment area in each of the plurality of pattern images by using a distribution of a pixel value, and performing processing of aligning the set alignment area.

In an exemplary embodiment, the generating of the training set may include generating a new pattern image from the plurality of pattern images through an interpolation or an extrapolation, and generating optical characteristic values corresponding to the new pattern image.

In order to achieve the above aspects, according to some exemplary embodiment of the present disclosure, provided is a lens simulation system, which may include: a memory storing one or more instructions; and one or more processors, in which the one or more processors may execute the one or more stored instructions to perform an operation of acquiring a deep learning model constructed to predict optical characteristic values of a lens from an input pattern image, an operation of predicting, through the acquired deep learning model, optical characteristic values of a target lens from a pattern image associated with the target lens, and an operation of using the predicted optical characteristic values of the target lens so as to simulate a visual field seen through the target lens.

In order to achieve the above aspects, according to other some exemplary embodiments of the present disclosure, provided is a lens simulation system, which may include: a memory storing one or more instructions; and one or more processor, in which the one or more processors may execute the one or more stored instructions to perform an operation of acquiring a dataset constituted by a plurality of pattern images and optical characteristic values of a lens corresponding to the plurality of pattern images; an operation of generating a training set by preprocessing the acquired dataset; and an operation of constructing a deep learning model predicting the optical characteristic values of the lens from an input pattern image by using the generated training set.

In order to achieve the above aspects, according to some exemplary embodiments of the present disclosure, provided is a computer program which may be coupled to a computing device and stored in a computer-readable recording medium in order to execute acquiring a deep learning model constructed to predict optical characteristic values of a lens from an input pattern image; predicting, through the acquired deep learning model, optical characteristic values of a target lens from a pattern image associated with the target lens; and using the predicted optical characteristic values so as to simulate a visual field seen through the target lens.

In order to achieve the above aspects, according to other some exemplary embodiments of the present disclosure, provided is a computer program which may be coupled to a computing device and stored in a computer-readable recording medium in order to execute acquiring a dataset constituted by a plurality of pattern images and optical characteristic values of a lens corresponding to the plurality of pattern images; generating a training set by preprocessing the acquired dataset; and constructing a deep learning model predicting the optical characteristic values of the lens from an input pattern image by using the generated training set.

### ADVANTAGEOUS EFFECTS

According to some exemplary embodiments of the present disclosure, optical characteristic values of a target lens are predicted through a deep learning model constructed to predict the optical characteristic values of the lens from a pattern image, and a defocus effect according to the predicted optical characteristic values is injected into an original visual field image, thereby accurately simulating the visual field seen through the target lens. When the target lens is an intraocular lens, a visual field seen through the intraocular lens can be accurately simulated, and in this case, before undergoing intraocular lens implantation, a patent (e.g., a patient with cataracts) can indirectly experience an effect of the corresponding surgery. Furthermore, simulation results for various intraocular lenses (e.g., monofocal intraocular lenses, multifocal intraocular lenses, and multiple intraocular lenses with different optical characteristics) can be a great help to the patient in choosing an intraocular lens suitable therefor.

Further, since the visual field seen through the target lens is simulated using the optical characteristic values of the target lens, there is no need to manufacture the target lens as a physical object. As a result, various lenses can be simulated without a limitation, and the cost required for simulation can be greatly reduced. Furthermore, a time required for simulation can also be significantly shortened.

Further, a training set for a deep learning model can be generated by aligning pattern locations of pattern images. As a result, a high-quality training set can be easily secured, and the prediction performance of the deep learning model can be greatly enhanced.

In addition, the training set for the deep learning model can be generated by augmenting a dataset composed of pattern images and optical characteristic values corresponding thereto through an interpolation or an extrapolation. As a result, a large quantity of training sets can be easily secured at a relatively low cost, and the prediction performance of the deep learning model can be further enhanced.

Further, an intensity of a blur filter can be determined by using optical characteristic values (e.g., an MTF value and a defocus value) of the target lens predicted through the deep learning model, and the blur filter having the determined intensity is applied to the original visual field image to accurately simulate the visual field seen through the target lens.

Further, a defocus effect according to an optical characteristic value corresponding to each of different object distance areas (e.g., a short-range area and a long-range area) within the original visual field image is injected to more accurately simulate the visual field seen through the target lens.

The effects according to the technical idea of the present disclosure are not limited to the aforementioned effect, and other effects, which are not mentioned above, will be apparent to a person having ordinary skill in the art from the following disclosure.

### DESCRIPTION OF DRAWINGS

FIG. 1 illustrates a light scattering phenomenon that may occur after implantation of a multifocal intraocular lens.

FIG. 2 is an exemplary diagram for describing a lens simulation system and an input/output thereof according to some exemplary embodiments of the present disclosure.

FIG. 3 is an exemplary flowchart schematically illustrating a lens simulation method according to some exemplary embodiments of the present disclosure.

FIG. 4 is an exemplary diagram for describing a method for constructing a deep learning model according to an exemplary embodiment of the present disclosure.

FIG. 5 is an exemplary diagram for describing a structure of the deep learning model according to an exemplary embodiment of the present disclosure.

FIG. 6 is an exemplary flowchart illustrating a pattern image aligning method according to an exemplary embodiment of the present disclosure.

FIGS. 7 to 9 are exemplary diagrams for further describing the pattern image aligning method according to an exemplary embodiment of the present disclosure.

FIG. 10 is an exemplary diagram for describing a dataset augmenting method according to an exemplary embodiment of the present disclosure.

FIG. 11 is an exemplary flowchart illustrating a visual field simulating method of a target lens according to an exemplary embodiment of the present disclosure.

FIGS. 12 and 13 are exemplary diagrams for further describing the visual field simulating method of the target lens according to an exemplary embodiment of the present disclosure.

FIG. 14 illustrates an exemplary computing device which may implement a lens simulation system according to some exemplary embodiments of the present disclosure.

### MODES OF THE INVENTION

Hereinafter, preferred exemplary embodiments of the present disclosure will be described in detail with reference to the accompanying drawings. Advantages and features of the present disclosure, and methods for accomplishing the same will be more clearly understood from embodiments described in detail below with reference to the accompanying drawings. However, the technical idea of the present disclosure is not limited to the following embodiments, and may be embodied in various different forms. The following embodiments are just for rendering the technical idea of the present disclosure complete and are set forth to provide a complete understanding of the scope of the present disclosure to a person with ordinary skill in the technical field to which the present disclosure pertains, and the present disclosure will only be defined by the scope of the claims.

When reference numerals refer to components of each drawing, it is to be noted that although the same components are illustrated in different drawings, the same components are denoted by the same reference numerals as possible. Further, in describing the present disclosure, a detailed description of known related configurations or functions may be omitted to avoid unnecessarily obscuring the subject matter of the present disclosure.

Unless otherwise defined, all terms (including technical and scientific terms) used in the present disclosure may be used as the meaning which may be commonly understood by the person with ordinary skill in the art, to which the present disclosure pertains. Terms defined in commonly used dictionaries should not be interpreted in an idealized or excessive sense unless expressly and specifically defined. The terminology used in the present disclosure is for the purpose of describing embodiments only and is not intended to limit the present disclosure. In the present disclosure, singular forms include even plural forms unless the context clearly indicates otherwise.

Further, in describing the components of the present disclosure, terms including first, second, A, B, (a), (b), and the like may be used. These terms are just intended to distinguish the components from other components, and the terms do not limit the nature, sequence, or order of the components. When it is disclosed that any component is “connected”, “coupled”, or “linked” to other components, it should be understood that the component may be directly connected or linked to other components, but another component may be “connected”, “coupled”, or “linked” between the respective components.

It is to be understood that the terms “comprises” and/or “comprising” used in the present disclosure does not exclude presence or addition of one or more other components, steps, operations, and/or elements with respect to stated components, steps, operations, and/or elements.

Hereinafter, various exemplary embodiments of the present disclosure will be described in detail with reference to the accompanying drawings.

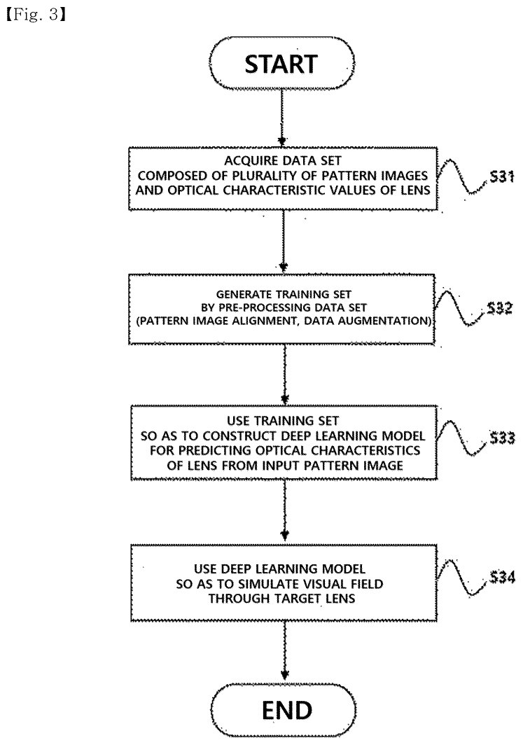

FIG. 2 is an exemplary diagram for describing a lens simulation system 20 according to some exemplary embodiments of the present disclosure.

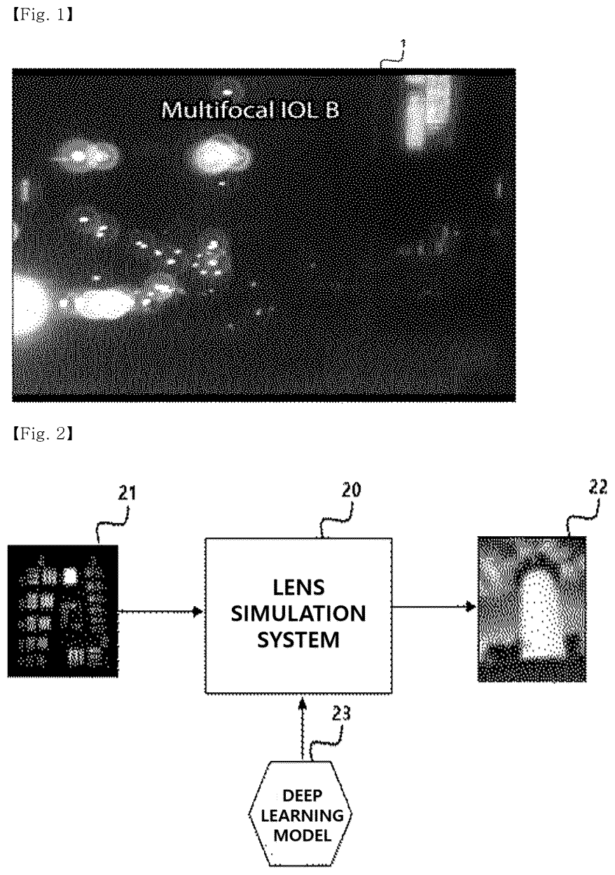

As illustrated in FIG. 1, the lens simulation system 20 may be a system which may simulate a visual field seen through a target lens. For example, the lens simulation system 20 may simulate the visual field seen through the target lens by generating a simulation visual field image 22 by injecting a defocus effect according to optical characteristic values of the target lens into an original visual field image (not illustrated). Hereinafter, for convenience of description, the lens simulation system 20 will be abbreviated as ‘simulation system 20’.

Specifically, the simulation system 20 may construct a deep learning model 23 that predicts the optical characteristic values of the target lens from a pattern image 21, predict the optical characteristic values of the target lens through the constructed deep learning model 23, and generate a simulation visual field image 22 by using the predicted characteristic values. In this case, the visual field seen through the target lens may be simulated without directly manufacturing the target lens, so simulations for various lenses with different optical characteristics may be easily performed. A detailed operation of the simulation system 20 will be described later in detail with reference to FIG. 3 and drawings therebelow.

The target lens is a lens which becomes a simulation target, and may be, for example, an intraocular lens, a contact lens, etc., but the scope of the present disclosure is not limited thereto. For example, the target lens may be another type of lens that is implanted into the eye or a lens (e.g., glasses) that is worn or positioned outside the eye.

Further, the optical characteristic values of the target lens may be, for example, values related to a modulation transfer function (MTF), a focal length, a refractive index, defocus, etc. However, the scope of the present disclosure is not limited to these examples. For reference, the defocus value is a value that indicates a degree to which the lens is out of focus, and may be, for example, a diopter-unit value (e.g., 0.0 diopter in the case of stigmatism) indicating a difference between a location where the image is formed and an original image plane (e.g., retina). However, the scope of the present disclosure is not limited thereto, and a unit, an expression method, etc., of the defocus value may be modified in any way. Since the defocus value may vary depending on the focal length of the lens (e.g., even though a distance between the lens and the image plane is set to the same, the defocus value may vary for each lens), the defocus value may become a value indicating the optical characteristics of the lens.

Further, the pattern image 21 is an image used to measure the optical characteristic values of the lens, and may be, for example, a USAF target image. However, the scope of the present disclosure is not limited thereto. For reference, the USAF target image may be used to measure an MTF (i.e., resolution) value of the lens, and those skilled in the art will already be familiar with a method for measuring the MTF value from the USAF target image, so a description thereof will be omitted.

The simulation system 20 may be implemented as at least one computing device. For example, all functions of the simulation system 20 may be implemented on one computing device, or a first function of the simulation system 20 may be implemented on a first computing device and a second function may be implemented on a second computing device. Alternatively, specific functions of the simulation system 20 may also be implemented on a plurality of computing devices.

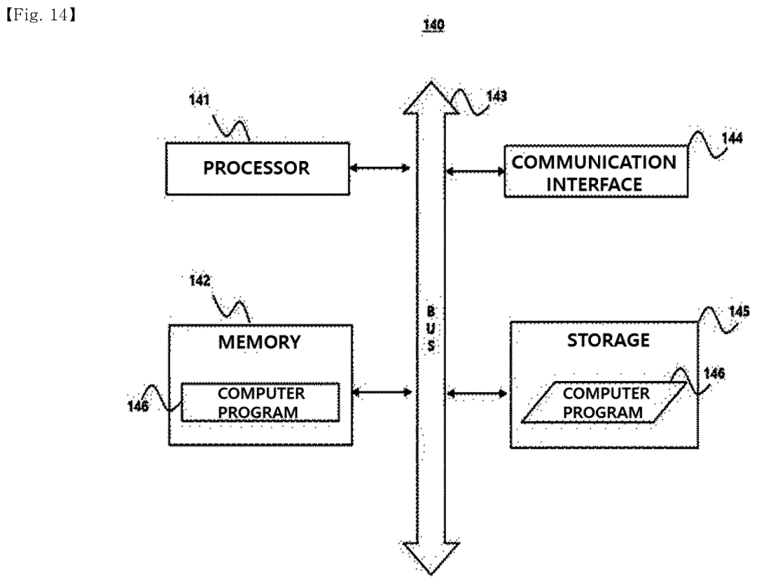

The computing devices may encompass a variety of different types of devices having computing functions, and for an example of such a device, see FIG. 14.

So far, the simulation system 20 according to some exemplary embodiments of the present disclosure has been described with reference to FIG. 2. Hereinafter, various methods that may be performed in the simulation system 20 will be described with reference to FIG. 3 and the drawings therebelow.

Hereinafter, for convenience of understanding, the description will continue assuming that all steps/operations of the methods to be described later are performed in the simulation system 20 described above. Therefore, when a subject of a specific step/operation is omitted, it may be understood that the specific step/operation is performed in the simulation system 20. However, in a real environment, some steps of the methods described below may also be performed on other computing devices.

FIG. 3 is an exemplary flowchart schematically illustrating a lens simulation method according to some exemplary embodiments of the present disclosure. However, this is only a preferred exemplary embodiment for achieving the purpose of the present disclosure, and it is obvious that some steps may be added or deleted as necessary.

As illustrated in FIG. 3, a lens simulation method according to exemplary embodiments may begin in a step (S31) of acquiring a dataset composed of a plurality of pattern images and optical characteristic values of the lens. As described above, the pattern image may be, for example, a USAF target image, and the optical characteristic values of the lens may be, for example, an MTF value (e.g., a root mean square (RMS) value of the MTF), and the defocus value. However, the scope of the present disclosure is not limited thereto.

For example, by mounting various lenses on an optical bench test with adjustable defocus values and photographing a USAF target, the defocus values of the corresponding lens and multiple USAF target images according thereto may be acquired. In addition, by analyzing each of the acquired USAF target images, an MTF value according to the defocus value of the corresponding lens may be measured.

Further, for example, the simulation system 20 may also acquire data (e.g., the USAF target image photographed with the corresponding lens and/or an MTF curve according to the defocus value of the corresponding lens) provided by a lens manufacturer by crawling a site of the lens manufacturer, etc.

In step S32, a training set for training the deep learning model may be generated by preprocessing the acquired dataset. However, a specific preprocessing method may vary depending on the exemplary embodiment.

In an exemplary embodiment, the simulation system 20 may perform preprocessing of aligning a plurality of pattern images included in the dataset. The preprocessing may be appreciated as a data cleaning process for enhancing a quality of the training set and a prediction performance of the deep learning model. For example, when a location of a pattern within an image is aligned (or matched) through the preprocessing, the prediction performance of the deep learning model may be significantly enhanced because the deep learning model is trained to predict the characteristics of the lens by focusing more on parts other than the location of the pattern. The exemplary embodiment will be described in detail with reference to FIGS. 6 to 9.

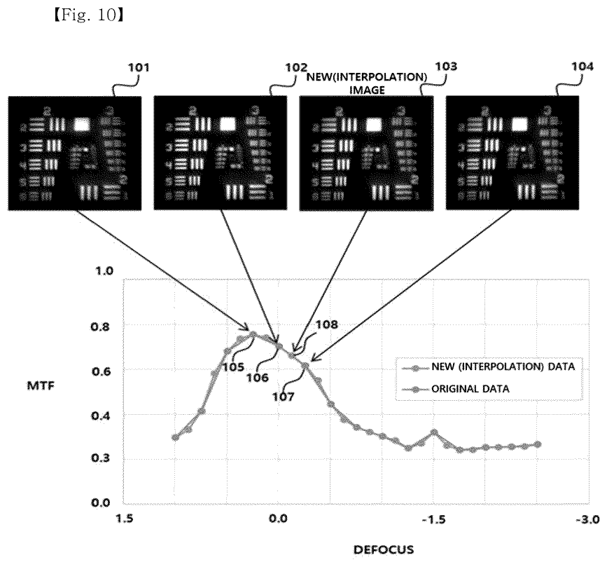

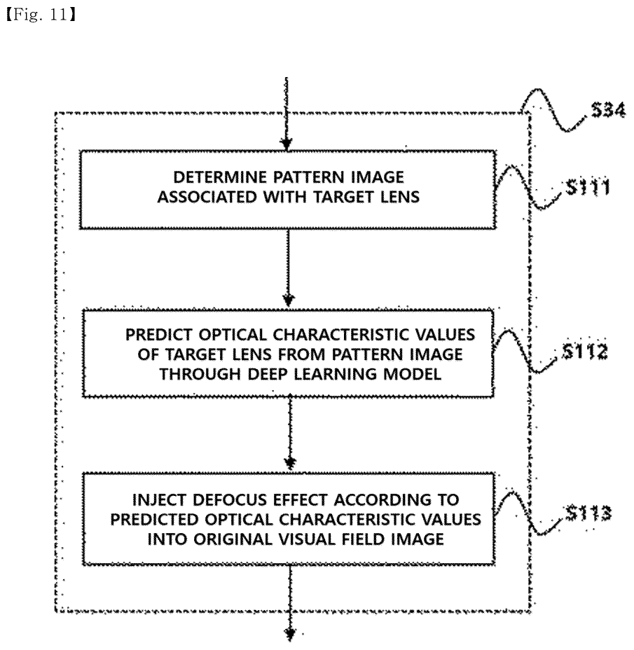

In an exemplary embodiment, the simulation system 20 may perform preprocessing of augmenting the dataset using the interpolation and/or the extrapolation. The preprocessing may be appreciated as a process for enhancing the prediction performance of the deep learning model through an increase in scale of the training set. The exemplary embodiment will be described in detail later with reference to FIG. 10.

In an exemplary embodiment, the simulation system 20 may also perform the preprocessing based on a combination of the exemplary embodiments described above. For example, the simulation system 20 may generate a rich and high-quality training set by augmenting the dataset through the interpolation and/or extrapolation and aligning a plurality of pattern images included in the augmented dataset.

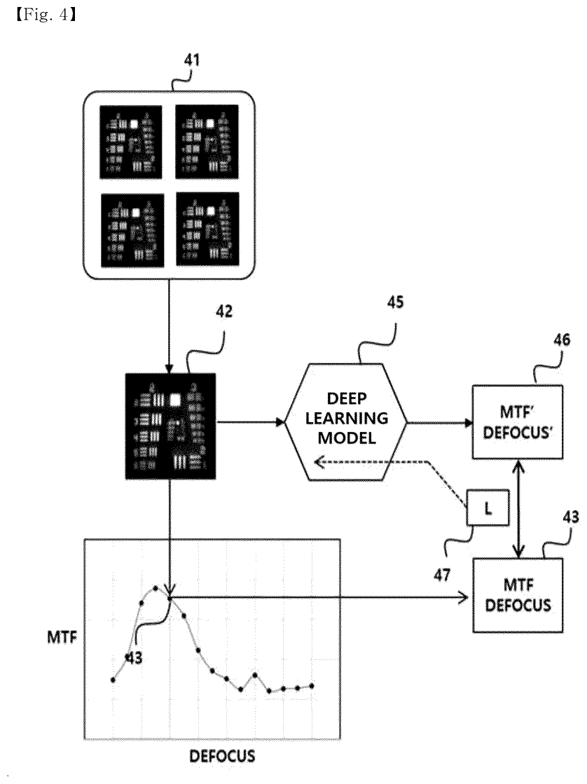

In step S33, the deep learning model may be constructed by using the training set. Here, the deep learning model may be a model that predicts the optical characteristics of the lens from an input pattern image. For example, as illustrated in FIG. 4, the simulation system 20 may predict an optical characteristic value 46 (e.g., an MTF curve) by inputting a pattern image 42 of the training set into the deep learning model 45, and train the deep learning model 45 by using a loss 47 based on a difference between the predicted value 46 and an optical characteristic value 43 (i.e., a correct answer) of the training set (that is, a weight of the deep learning model 45 is updated by backpropagating the loss 47). As such a training process is repeated with respect to multiple pattern images 41 included in the training set, the optical characteristic value of the lens may be accurately predicted from the pattern image into which the deep learning model 45 is input. FIG. 4 illustrates that the deep learning model 45 is a model that predicts both the MTF value and the defocus value as an example, and a reason for predicting both values is that both values are closely associated with each other (that is, the MTF value and the defocus value as both values forming the MTF curve are values very closely associated with each other because the MTF value of the lens varies depending on the defocus value).

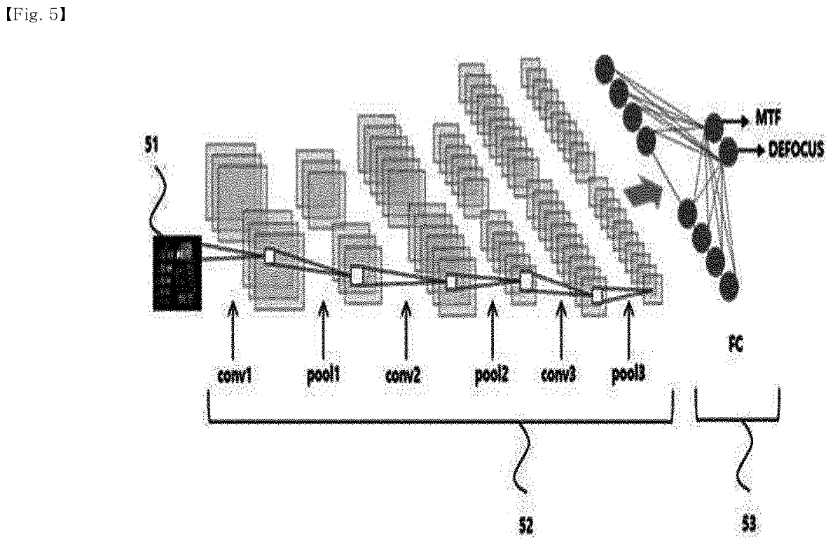

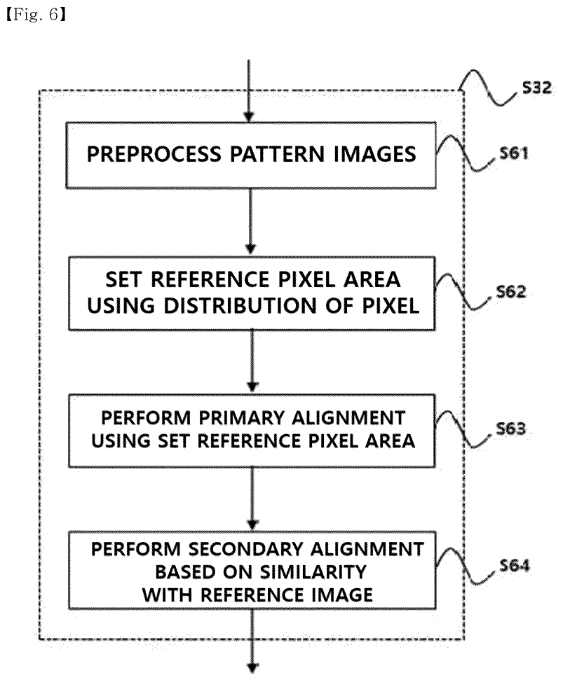

Meanwhile, a structure of the deep learning model (e.g., 45) may be variously designed. For example, as illustrated in FIG. 5, the deep learning model may be designed as a convolutional neural networks (CNN) based model. Since the convolutional neural network as a model specified to image analysis may excellently extract a feature associated with the optical characteristic value of the lens from a pattern image 51, the convolutional neural network may ensure a high prediction performance. FIG. 5 illustrates that the deep learning model is constituted by a plurality of feature extraction layers 52 which extracts a feature from a pattern image 51 and an output layer 53 which predicts the optical characteristic values (e.g., the MTF value and the defocus value) by synthesizing the extracted feature, the feature extraction layers 52 are constituted by a convolution layer and a pooling layer, and the output layer 53 is constituted by a fully-connected layer (or a dense layer) as an example. As another example, the deep learning model may also be designed as an artificial neural networks (ANN) based model. As yet another example, the deep learning model may also be designed as a self-attention based model like a vision transformer (Vit). However, the scope of the present disclosure is not limited to the examples, and the deep learning model may also be designed as a neural network having a different structure.

Further, the deep learning model (e.g., 45) may also be constructed for each type of the lens. For example, the simulation system 20 may construct a first deep learning model for first lenses (i.e., lenses which may clearly see an object in a short range) suitable for a short range and construct a second deep learning model for second lenses (i.e., lenses which may clearly see an object in a long range) suitable for a long range. Alternatively, the simulation system 20 may also construct a first deep learning model for monofocal lenses (e.g., monofocal intraocular lenses) and construct a second deep learning model for multifocal lenses (e.g., multifocal intraocular lenses). Alternatively, the simulation system 20 may also construct a first deep learning model for the intraocular lens and construct a second deep learning model for the contact lens.

This will be described by referring back to FIG. 3.

In step S34, the visual field seen through the target lens may be simulated by using the constructed deep learning model. For example, the simulation system 20 predicts the optical characteristic values of the target lens from the pattern image associated with the target lens through the deep learning model, and injects a defocus effect according to the predicted characteristic values into the original visual field image to generate a simulation visual field image (i.e., an image of simulating the visual field seen upon wearing the target lens). Alternatively, the simulation system 20 may also generate the simulation visual field image by continuously injecting the defocus effect according to the predicted optical characteristic values into an original visual field image constituted by a plurality of frames. A detailed process of this step will be described later in more detail with reference to FIGS. 11 to 13.

So far, the lens simulation method according to some exemplary embodiments of the present disclosure has been described with reference to FIGS. 3 to 5. According to the above-described method, the deep learning model may constructed to predict the optical characteristic values of the lens from the pattern image, the optical characteristic values of the target lens may be predicted through the constructed deep learning model, and the visual field seen through the target lens may be accurately simulated through the target lens by using the predicted optical characteristic values. For example, when the target lens is an intraocular lens, a visual field seen through the intraocular lens may be accurately simulated, and in this case, before undergoing intraocular lens implantation, a patient (e.g., a patient with cataracts) may indirectly experience an effect of the corresponding surgery. Further, since the visual field seen through the target lens is simulated using the optical characteristic values of the target lens, there is no need to manufacture the target lens as a physical object. As a result, various lenses may be simulated without a limitation, and the cost required for simulation may be greatly reduced. Furthermore, a time required for simulation may also be significantly shortened.

Hereinafter, a pattern image aligning method according to an exemplary embodiment of the present disclosure will be described with reference to FIGS. 6 to 9.

FIG. 6 is an exemplary flowchart illustrating a pattern image aligning method according to an exemplary embodiment of the present disclosure. However, this is only a preferred exemplary embodiment for achieving the purpose of the present disclosure, and it is obvious that some steps may be added or deleted as necessary.

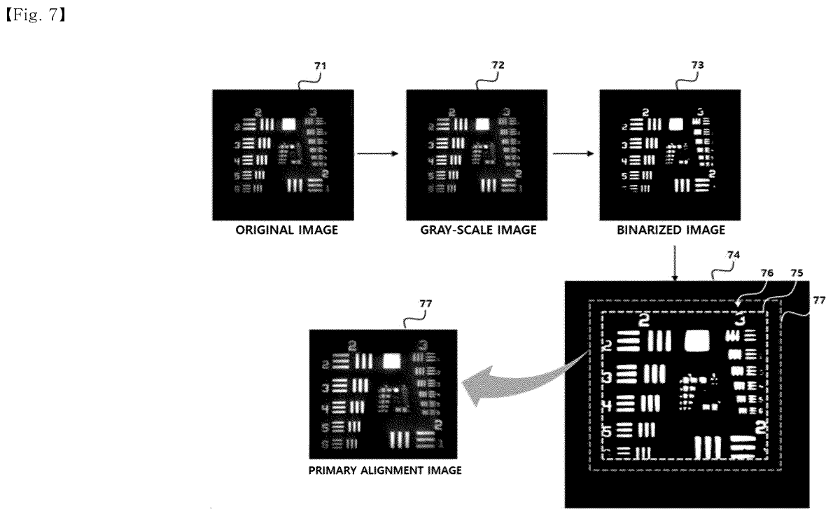

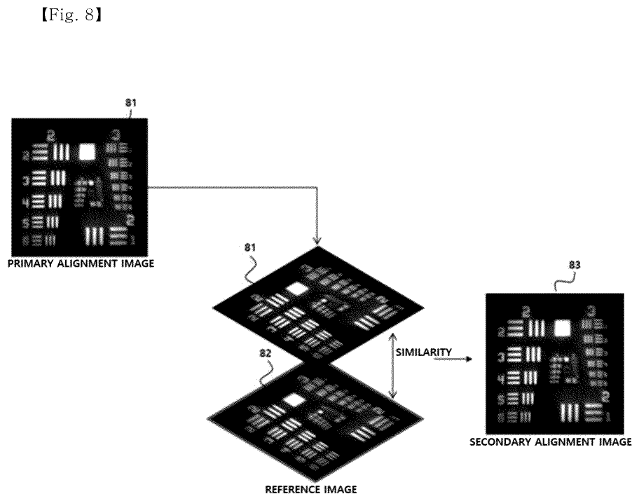

As illustrated in FIG. 6, the exemplary embodiment may begin in a step (S61) of preprocessing each of the plurality of pattern images. Here, preprocessing for the pattern image may include various types of preprocessings that may be performed on an image, such as grayscale conversion, binarization, de-noising, etc. For example, as illustrated in FIG. 7, the simulation system 20 may convert an original pattern image 71 to a grayscale (see a grayscale image 72) and binarize the converted pattern image 72 (see a binarized image 73). By doing so, noise included in the original pattern image 71 may be removed, and an alignment area to be described later may be accurately set.

In step S62, the alignment area may be set in each of the preprocessed pattern images using a distribution of pixel values. For example, as illustrated in FIG. 7, the simulation system 20 may set an area 75 (i.e., a pattern area excluding a background) in which pixels having values which are equal to or more than a threshold value are distributed in the binarized pattern image 73 as the alignment area. In other words, the simulation system 20 may check the pixel value distribution of the binarized pattern image 73 and set the alignment area 75 so that outermost pixels among the pixels have the values which are equal to or more than the threshold value.

In step S63, a primary alignment may be performed using the set alignment area. For example, the simulation system 20 may perform processing which allows the alignment areas (e.g., 75) set in the plurality of pattern images, respectively to be aligned. However, a specific processing method thereof may also vary.

For example, as illustrated in FIG. 7, the simulation system 20 may set a padding area 76 around the alignment area 75 and extract the alignment area 75 and the padding area 76 (see an extraction area 77). By repeating such a process for the plurality of pattern images, the plurality of pattern images may be easily aligned. For reference, a size of the padding area 76 may be set to be proportional to a size of the alignment area 75 or the size of the padding area 76 and the size of the alignment area 75 may be set to the same size. In addition, when a size of the extraction area 77 is different for each pattern image, processing (e.g., resizing, etc.) may also be further performed which matches the size of the extraction area 77.

As another example, the simulation system 20 may also perform alignment processing by extracting only the alignment area (e.g., 75) without setting the padding area (e.g., 76), and repeatedly performing such a process for the plurality of pattern images.

As yet another example, the simulation system 20 may also perform the alignment processing by not extracting the alignment area (e.g., 75) but matching an alignment area of a specific pattern image with an alignment area of another pattern image (e.g., performing shifting, resizing, etc., to match the alignment area).

In step S64, a second alignment may be performed based on a similarity with a reference image. For example, as illustrated in FIG. 8, the simulation system 20 may calculate a similarity between a primarily aligned pattern image 81 and a reference image 82, and matches the pattern image 81 to suit the reference image 82 so that the calculated similarity becomes minimum (alternatively, a threshold value or less) to perform the secondary alignment (see a secondarily aligned pattern image 83). At this time, the similarity between the pattern image 81 and the reference image 82 will be able to be calculated based on a correlation coefficient, but the scope of the present disclosure is not limited thereto, and the similarity between both images 81 and 82 may be calculated by a different method. Further, the reference image 82 may also be an image selected among a plurality of pattern images which are primarily aligned, and may also be another pattern image which is prepared in advance.

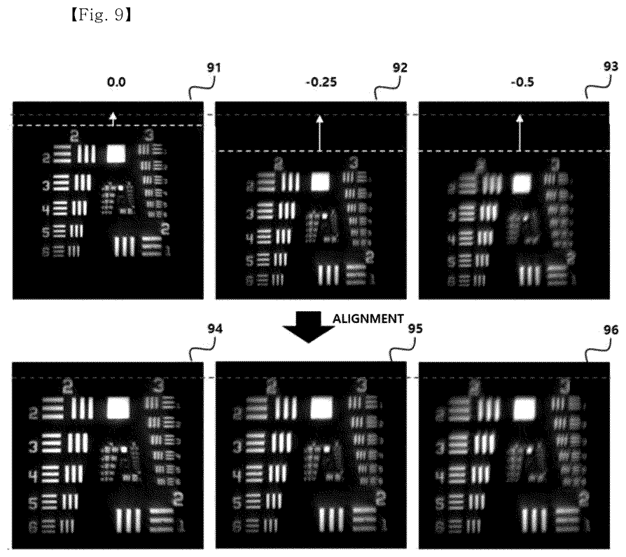

FIG. 9 illustrates results 94 to 96 in which a plurality of pattern images 91 to 93 are aligned through steps S61 to S64 described above as an example.

Meanwhile, in some cases, alignment of the plurality of pattern images may be performed using only any one of the primary alignment method or the secondary alignment method.

So far, the pattern image aligning method according to an exemplary embodiment of the present disclosure will be described with reference to FIGS. 7 to 9. According to the above-described method, a high-quality training set for the deep learning model may be easily generated by aligning pattern locations of the plurality of pattern images, and a high-performance deep learning model may be easily constructed by using the generated training set.

Hereinafter, a dataset augmenting method according to an exemplary embodiment of the present disclosure will be described with reference to FIG. 10.

FIG. 10 is an exemplary diagram for describing a dataset augmenting method according to an exemplary embodiment of the present disclosure. In particular, FIG. 10 illustrates a case of generating new data 103 and 108 in original data (e.g., 101 and 105) through the interpolation as an example, and it is assumed that the optical characteristic values constituting the dataset are the MTF value and the defocus value.

As illustrated in FIG. 10, a new pattern image 103 may be generated from original pattern images 101, 102, and 104 through the interpolation. For example, the simulation system 20 interpolates pixel values of the original pattern images 102 and 104 having different defocus values to generate a new pattern image 103 having a defocus value between the original pattern images 102 and 104. The interpolation of the pixel value will be able to be performed through, for example, a Gaussian interpolation, but the scope of the present disclosure is not limited thereto, and the interpolation of the pixel value may be performed through another interpolation. Further, although not illustrated in FIG. 10, the simulation system 20 may also generate a new pattern image (not illustrated) having a defocus value which deviates from ranges of the original pattern images (e.g., 101, 102, and 104) (i.e., a range of the defocus value) through the extrapolation.

Next, an MTF value corresponding to the new pattern image 103 may be generated. For example, the simulation system 20 interpolates MTF values (e.g., 106 and 107) of the original pattern images (e.g., 102 and 104) to calculate an MTF value 108 of the new pattern image 103. Alternatively, the simulation system 20 may also measure the MTF value 108 by analyzing the new pattern image 103.

The simulation system 20 may generate various coordinate values (i.e., the defocus value and the MTF value) on the MTF curve (see a graph shown at the bottom of FIG. 10) and new pattern images corresponding thereto by repeatedly performing the above-described process for various pattern images having different defocus values.

So far, the dataset augmenting method according to an exemplary embodiment of the present disclosure has been described with reference to FIG. 10. According to the above-described method, a large quantity of training sets for the deep learning model may be easily generated by augmenting the dataset through the interpolation and/or the extrapolation, and a high-performance deep learning model may be easily constructed by using the large quantity of training sets.

Hereinafter, a visual field simulating method of the target lens according to an exemplary embodiment of the present disclosure will be described with reference to FIGS. 11 to 13.

FIG. 11 is an exemplary flowchart illustrating a visual field simulating method of a target lens according to an exemplary embodiment of the present disclosure. However, this is only a preferred exemplary embodiment for achieving the purpose of the present disclosure, and it is obvious that some steps may be added or deleted as necessary.

As illustrated in FIG. 11, the exemplary embodiment may begin in the step (S11) of determining the pattern image associated with the target lens. Here, the pattern image associated with the target lens may be, for example, a pattern image photographed through the target lens or a lens (hereinafter, referred to as ‘similar lens’) having a similar optical characteristic to the target lens, a pattern image generated from pattern images photographed through the similar lens through the interpolation or the extrapolation, etc., but the scope of the present disclosure is not limited thereto. For example, the simulation system 20 may receive, as an input, the pattern image associated with the target lens from the user, and may automatically determine the pattern image associated with the target lens through prestored pattern images. In other words, the simulation system 20 may also select the pattern image associated with the target lens among the prestored pattern images based on a similarity between the lens which photographs the pattern image and the target lens (i.e., a similarity between the optical characteristics).

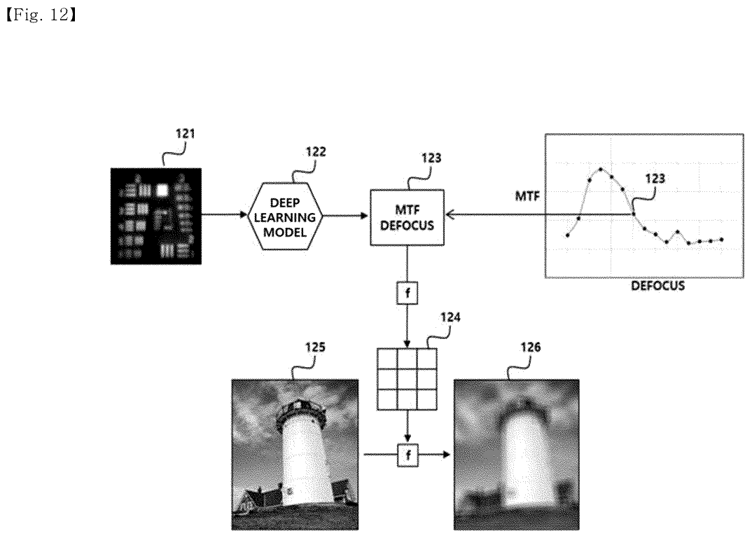

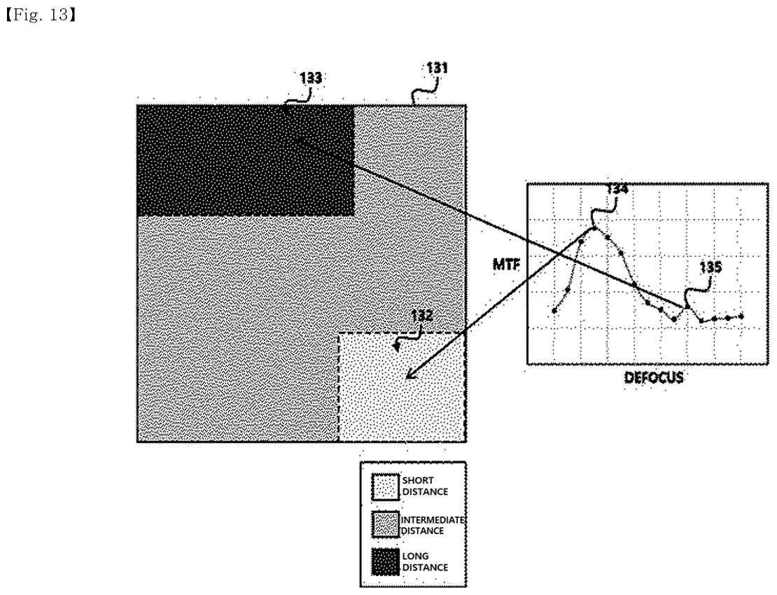

In step S112, the optical characteristic value of the target lens may be predicted from the pattern image associated with the target lens through the deep learning model. For example, as illustrated in FIG. 12, the simulation system 20 may input a pattern image 121 associated with the target lens into a trained deep learning model 122, and acquire a predicted optical characteristic value 123 from the deep learning model 122. FIG. 12 illustrates a case where the deep learning model 122 is trained to predict the MTF value and the defocus value as an example. Further, the simulation system 20 may also predict MTF values (i.e., MTF curves) according to different defocus values by using multiple pattern images (e.g., 121) associated with the target lens.

For reference, when the optical characteristic values of the target lens are already known, steps S111 and S112 may also be omitted.

In step S113, the defocus effect according to the predicted optical characteristic values may be injected into the original visual field image. Here, the defocus effect may include, for example, the blur effect, but the scope of the present disclosure is not limited thereto. For example, as illustrated in FIG. 12, the simulation system 20 determines an intensity (i.e., a filter value according to the intensity) of a blur filter 124 (e.g., a convolution filter) using predicted optical characteristic values 123, and applies the blur filter 124 having the determined intensity to an original visual field image 125 to inject the blur effect. In addition, as a result, a simulation visual field image 126 may be generated. At this time, the intensity of the blur filter 124 may be determined to a larger value as the MTF value is smaller or as a magnitude (i.e., an absolute value) of the defocus value becomes larger.

As a more specific example, the simulation system 20 may determine an area (e.g., an area where an object distance is different from an optimal distance) into which the defocus effect is to be injected in the original visual field image (e.g., 125) by using the optical distance of the target lens, and inject the defocus effect according to the optical characteristic values of the target lens into the determined area. In other words, the simulation system 20 may generate the simulation visual field image (e.g., 126) by applying the blur filter (e.g., 124) to the determined area.

Further, for example, as illustrated in FIG. 13, the simulation system 20 may inject a defocus effect according to optical characteristic values 134 corresponding to a first object distance into a first area 132 having a first object distance in the original simulation image 131, and inject a defocus effect according to optical characteristic values 135 corresponding to a second object distance into a second area 133 having a second object distance. FIG. 13 illustrates a case where the optical characteristic values are the MTF value and the defocus value, and the first area 132 and the second area 133 are a short-range area and a long-range area, respectively, as an example. As a more specific example, when the target lens is a lens (e.g., a monofocal intraocular lens) suitable for an intermediate distance, the simulation system 20 predicts the optical characteristic values 134 and 135 for the short-range area 132 and the long-range area 133, respectively, and injects the defocus effects according to the predicted optical characteristic values 134 and 135 into the corresponding areas 132 and 133 to generate a sophisticated simulation visual field. As another example, when the target lens is a lens (e.g., multifocal intraocular lens) suitable for both the short range and the long range, the simulation system 20 may inject a defocus effect according to optical characteristic values corresponding to the intermediate area (i.e., an area positioned between focal lengths of the target lens) of the original visual field image 131. In addition, the simulation system 20 may also inject the defocus effects according to the optical characteristic values corresponding to the short-range area 132 and the long-range area 133 (e.g., a defocus effect having a weak intensity may also be injected depending on the MTF value). By doing so, the sophisticated simulation visual field image may be generated. For reference, an MTF value of the target lens corresponding to a specific object distance may be determined based on the defocus value. For example, when the target lens is the lens suitable for the intermediate distance, the defocus value at the intermediate distance will be close to ‘0.0’, and as the object distance changes, the defocus value will also change accordingly, so the MTF values for different object distances may be determined by the defocus value (e.g. among multiple optical characteristic values predicted by the deep learning model, the optical characteristic value corresponding to the specific object distance may be determined by the defocus value).

So far, the visual simulation method of the target lens according to an exemplary embodiment of the present disclosure has been described with reference to FIGS. 11 to 13. According to the above-described method, the intensity of the blur filter may be determined by using optical characteristic values (e.g., the MTF value and the defocus value) of the target lens predicted through the deep learning model, and the blur filter having the determined intensity is applied to the original visual field image to accurately simulate the visual field seen through the target lens. Further, the defocus effect according to the optical characteristic value corresponding to each of different object distance areas (e.g., a short-range area and a long-range area) of the original visual field image is injected to more accurately simulate the visual field seen through the target lens.

Hereinafter, an exemplary computing device 140 which may implement the simulation system 20 according to some exemplary embodiments of the present disclosure will be described with reference to FIG. 14.

FIG. 14 is an exemplary hardware configuration diagram illustrating the computing device 140.

As illustrated in FIG. 14, the computing device 140 may include one or more processors 141, a bus 143, a communication interface 143, a memory 142 loading a computer program performed by the processor 141, and a storage 145 storing a computer program 146. However, only components related to the exemplary embodiment of the present disclosure are illustrated in FIG. 14. Accordingly, those skilled in the art will appreciate that the present disclosure may further include general-purpose components other than the components illustrated in FIG. 14. That is, the computing device 140 may further include various components in addition to the components illustrated in FIG. 14. In some cases, the computing device 140 may also be implemented in a form in which some of the components illustrated in FIG. 14 are omitted.

The processor 141 may control an overall operation of each component of the computing device 140. The processor 141 may be configured to include a central processing unit (CPU), a micro processor unit (MPU), a micro controller unit (MCU), a graphic processing unit (GPU), or any type of processor well-known in a technical field of the present disclosure. Further, the processor 141 may perform an operation of at least application or program for executing the method/operation according to various exemplary embodiments of the present disclosure. The computing device 140 may provide one or more processors.

Next, the memory 142 may store various types of data, instructions, and/or information. The memory 142 may load one or more programs 146 from the storage 145 in order to execute the method/operation according to various exemplary embodiments of the present disclosure. The memory 142 will be able to be implemented as a volatile memory such as RAM, but a technical scope of the present disclosure is not limited thereto.

Next, the bus 143 may provide a communication function between the components of the computing device 140. The bus 143 may be implemented as various types of buses such as an address bus, a data bus, and a control bus.

Next, the communication interface 144 may support wired/wireless Internet communication of the computing device 140. Further, the communication interface 144 may also support various communication schemes in addition to the internet communication. To this end, the communication interface 144 may be configured to include a communication module well-known in the technical field of the present disclosure.

Next, the storage 145 may non-temporarily store one or more computer programs 146. The storage 145 may be configured to include a nonvolatile memory such as a read only memory (ROM), an erasable programmable ROM (EPROM), an electrically erasable programmable ROM (EEPROM), a flash memory or the like, a hard disk, a removable disk, or any type of computer-readable recording medium well-known in the art to which the present disclosure pertains.

When the computer program 146 is loaded to the memory 142, the computer program 146 may include one or more instructions that cause the processor 141 to perform methods/operations according to various exemplary embodiments of the present disclosure. That is, the processor 141 may perform the methods/operations according to various exemplary embodiments of the present disclosure by executing one or more instructions. Here, the instructions are a series of computer-readable instructions grouped based on a function and indicate components of the computer program or those that are executed by the processor.

For example, the computer program 146 may include instructions for performing an operation of acquiring a deep learning model constructed to predict optical characteristic values of a lens from an input pattern image, an operation of predicting optical characteristic values of a target lens from a pattern image associated with the target lens using the acquired deep learning model, and an operation of simulating a visual field seen through the target lens using the predicted optical characteristic values of the target lens. In such a case, a simulation system 20 according to some exemplary embodiments of the present disclosure may be implemented through a computing device 140.

So far, the exemplary computing device 140 which may implement the simulation system 20 according to some exemplary embodiments of the present disclosure has been described with reference to FIG. 14.

Various exemplary embodiments of the present disclosure and effects according to the exemplary embodiments have been described with reference to FIGS. 1 to 14 so far. The effects according to the technical idea of the present disclosure are not limited to the aforementioned effect, and other effects, which are not mentioned above, will be apparent to a person having ordinary skill in the art from the following disclosure.

The technical ideas of the present disclosure described so far may be implemented as computer-readable codes on a computer-readable medium. The computer-readable recording medium may be, for example, a removable recording medium (CD, DVD, Blu-ray disc, USB storage device, removable hard disk) or a fixed recording medium (ROM, RAM, computer-attached hard disk). The computer program recorded on the computer-readable recording medium may be transmitted to another computing device through a network such as the Internet and installed on the other computing device, thereby allowing the computer program to be used on the other computing device.

Hereinabove, even if it is described that all of constituent elements constituting the exemplary embodiment of the present disclosure are coupled as a single unit or coupled to be operated as a single unit, the technical idea of the present disclosure is not necessarily limited to the exemplary embodiment. That is, among the components, one or more constituent elements may be selectively coupled to be operated within the scope of the object of the present disclosure.

Although operations are illustrated in the drawings in a particular order, this should not be understood to mean that the operations must be performed in the particular order illustrated or in any sequential order, or that all illustrated operations must be performed to achieve the desired results. In certain situations, multitasking and parallel processing may be advantageous. Furthermore, the separation of the various components in the exemplary embodiments described above should not be construed as necessarily requiring such separation, and it should be understood that the described program components and systems may generally be integrated together into a single software product or packaged into multiple software products.

Hereinabove, the exemplary embodiments of the present disclosure have been described with the accompanying drawings, but it may be understood by those skilled in the art that the present disclosure may be executed in other detailed forms without changing the technical spirit or requisite features of the present disclosure. Therefore, it should be appreciated that the aforementioned exemplary embodiments are illustrative in all aspects and are not restricted. The protection scope of the present disclosure should be interpreted by the appended claims and all technical spirit in the equivalent range thereto should be interpreted to be embraced by the claims of the technical idea defined by the present disclosure.

1. A lens simulation method performed by at least one computing device, comprising:
acquiring a deep learning model constructed to predict optical characteristic values of a lens from an input pattern image;
predicting, through the acquired deep learning model, optical characteristic values of a target lens from a pattern image associated with the target lens; and
using the predicted optical characteristic values so as to simulate a visual field seen through the target lens.

2. The lens simulation method of claim 1, wherein the pattern image is a USAF target image.

3. The lens simulation method of claim 1, wherein the optical characteristic values include a modulation transfer function (MTF) value and a defocus value.

4. The lens simulation method of claim 1, wherein the deep learning model is a convolutional neural network based model.

5. The lens simulation method of claim 1, wherein the target lens is an intraocular lens.

6. The lens simulation method of claim 1, wherein the deep learning model is constructed through
a process of acquiring a dataset constituted by a plurality of pattern images and optical characteristic values corresponding to the plurality of pattern images,
a process of generating a training set by aligning the plurality of pattern images, and
a process of learning by using the training set.

7. The lens simulation method of claim 1, wherein the deep learning model is constructed through
a process of acquiring a dataset constituted by a plurality of pattern images and optical characteristic values corresponding to the plurality of pattern images,
a process of generating the training set by augmenting the dataset through an interpolation or an extrapolation, and
a process of learning by using the training set.

8. The lens simulation method of claim 1, wherein the simulating includes injecting a defocus effect according to the predicted optical characteristic values into an original visual field image.

9. The lens simulation method of claim 8, wherein the predicted optical characteristic values include the modulation transfer function (MTF) value and the defocus value, and
the injecting of the defocus effect includes
determining an intensity of a blur filter by using the MTF value and the defocus value, and
applying the blur filter having the determined intensity to the original visual field image.

10. The lens simulation method of claim 9, wherein the intensity of the blur filter is determined as a larger value as the MTV value is smaller, and
determined as a larger value as a magnitude of the defocus value is larger.

11. The lens simulation method of claim 8, wherein the predicted optical characteristic values include a first characteristic value corresponding to a first object distance and a second characteristic value corresponding to a second object distance different from the first object distance, and
the injecting of the defocus effect includes
injecting a defocus effect according to the first characteristic value into an area having the first object distance in the original visual field image, and
injecting a defocus effect according to the second characteristic value into an area having the second object distance in the original visual field image.

12. A lens simulation method performed by at least one computing device, comprising:
acquiring a dataset constituted by a plurality of pattern images and optical characteristic values of a lens corresponding to the plurality of pattern images;
generating a training set by preprocessing the acquired dataset; and
constructing a deep learning model predicting the optical characteristic values of the lens from an input pattern image by using the generated training set.

13. The lens simulation method of claim 12, wherein the generating of the training set includes
setting an alignment area in each of the plurality of pattern images by using a distribution of a pixel value, and
performing processing of aligning the set alignment area.

14. The lens simulation method of claim 13, wherein the setting of the alignment area includes
converting the plurality of pattern images into a gray scale,
binarizing the converted pattern images, and
setting the alignment area in the binarized pattern images by using the distribution of the pixel value.

15. The lens simulation method of claim 13, wherein the performing of the processing includes
setting a padding area around the alignment area, and
extracting the alignment area and the set padding area.

16. The lens simulation method of claim 12, wherein the generating of the training set includes aligning, based on a similarity with a reference image, the plurality of pattern images according to the reference image.

17. The lens simulation method of claim 12, wherein the generating of the training set includes
generating a new pattern image from the plurality of pattern images through an interpolation or an extrapolation, and
generating optical characteristic values corresponding to the new pattern image.

18. A lens simulation system comprising:
a memory storing one or more instructions; and
one or more processors,
wherein the one or more processors execute the one or more stored instructions to perform
an operation of acquiring a deep learning model constructed to predict optical characteristic values of a lens from an input pattern image,
an operation of predicting, through the acquired deep learning model, optical characteristic values of a target lens from a pattern image associated with the target lens, and
an operation of using the predicted optical characteristic values of the target lens so as to simulate a visual field seen through the target lens.
